(19) United States
(12) Patent Application Publication
(10) Pub. No.: US 2014/0049890 A1
(43) Pub. Date: Feb. 20, 2014

(54) ELECTRONIC DEVICE

(71) Applicants: HON HAI PRECISION INDUSTRY CO., LTD., New Taipei (TW); Fu Tai Hua Industry (Shenzhen) Co., Ltd., Shenzhen (CN)

(72) Inventor: ZI-MING TANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/961,678

(22) Filed: Aug. 7, 2013

(30) Foreign Application Priority Data
Aug. 14, 2012 (CN) 2012102878721

(51) Int. Cl. H01R 13/518

(52) U.S. Cl. CPC H01R 13/518
USPC 361/679.4

(57) ABSTRACT

An electronic device includes a housing, an I/O connector, and a positioning member. The housing defines a mounting opening at a sidewall of the housing, and a mounting groove communicating with the mounting opening and an inner space of the housing. The I/O connector is positioned in the mounting groove, and partly received in the mounting opening. The positioning member is made of electrically conductive materials, and is fixed within the mounting groove for positioning the I/O connector. The positioning member includes at least one elastic sheet. The at least one elastic sheet elastically resists against the I/O connector.

### BACKGROUND

1. Technical Field

The present disclosure relates to electronic devices, and particularly to an electronic device including an I/O (Input/Output) connector.

2. Description of Related Art

An I/O connector (Input/Output connector) of an electronic device may be applied as a data communication interface and a charging interface. The I/O connector needs to be accurately and steadily positioned in the electronic device by a positioning mechanism. Furthermore, the I/O connector needs to be electrically connected to at least one portion of the positioning mechanism. The positioning mechanism may lock the I/O connector to a housing of the electronic device by a screw, and make a portion of the positioning mechanism to contact the I/O connector. In order to make the positioning mechanism electrically connected to the I/O connector, sizes of the positioning mechanism and the I/O connector are required to be accurately produced. Thus, a cost of manufacturing the positioning mechanism and the I/O connector is thereby relatively high.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a partial, isometric view of an embodiment of an electronic device.

FIG. 2 is a partial, exploded view of the electronic device shown in FIG. 1.

FIG. 3 is similar to FIG. 2, but shown from another aspect.

FIG. 4 is a cross-sectional view of the electronic device taken along line IV-IV in FIG. 1.

### DETAILED DESCRIPTION

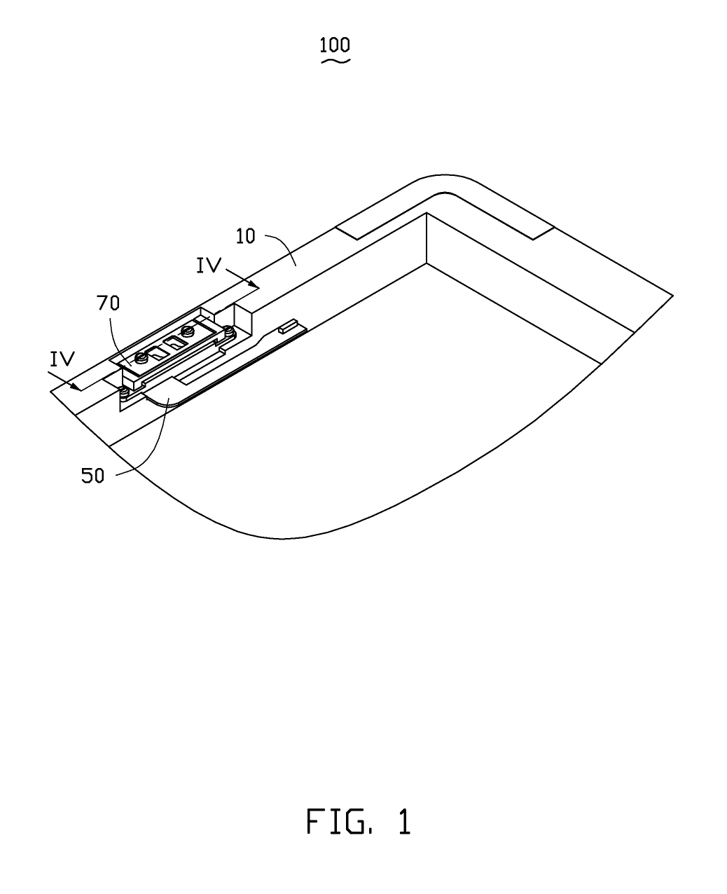

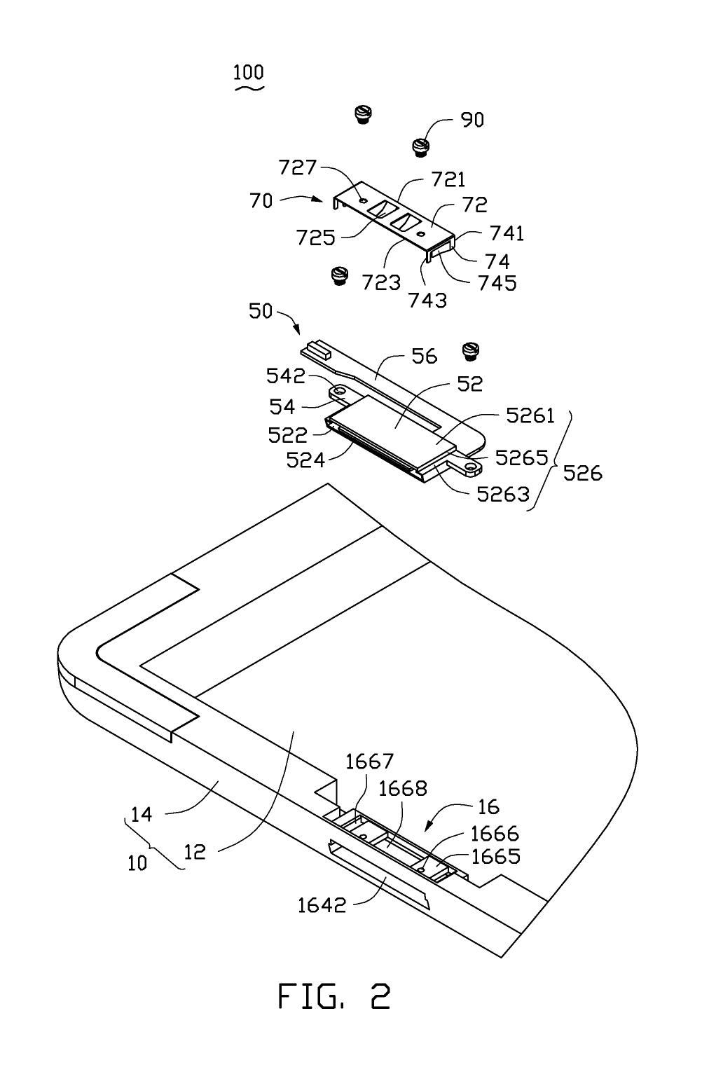

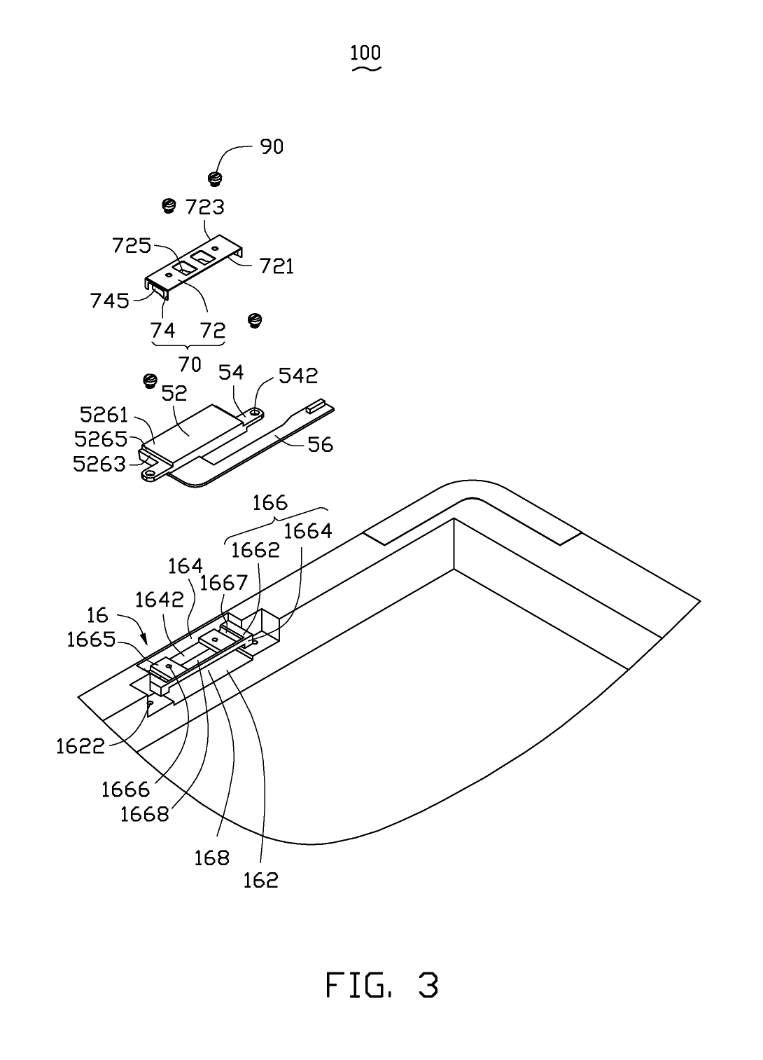

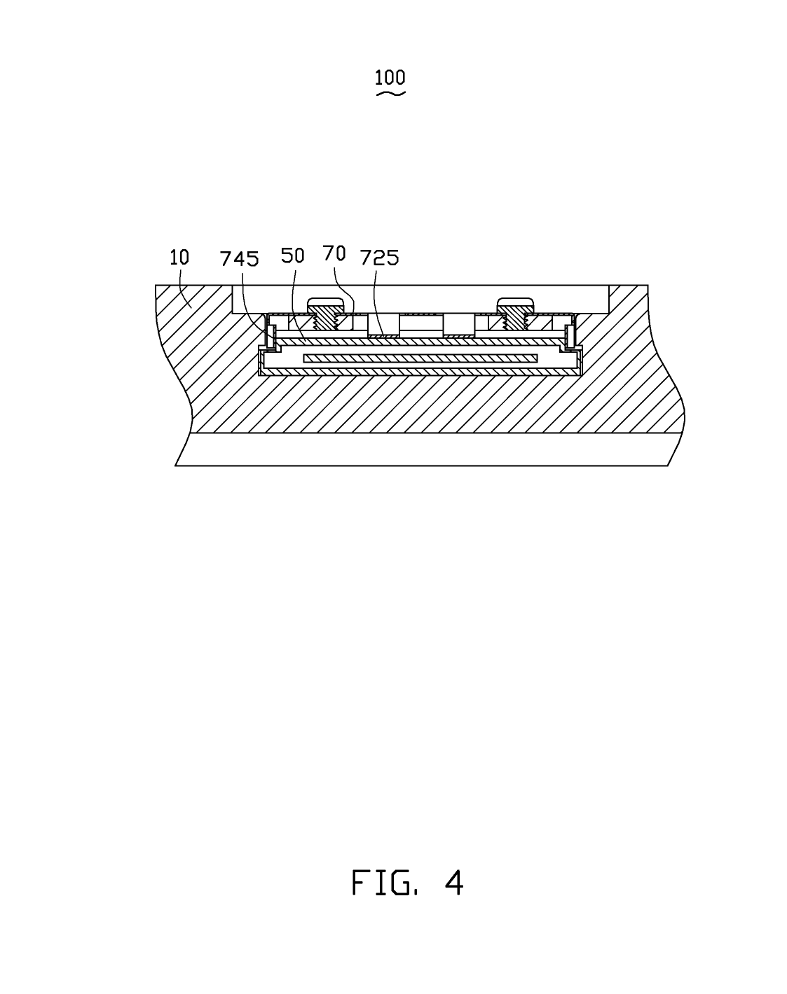

FIGS. 1 to 4 show one embodiment of an electronic device 100. The electronic device 100 may be a tablet computer, a mobile phone, a digital cameral, an MP3 player, an MP4 player, a digital photo frame, or a liquid crystal display (LCD) television, for example. In an illustrated embodiment, the electronic device 100 is a portable electronic device in the form of a tablet computer.

The electronic device 100 includes a housing 10, an I/O connector 50, a positioning member 70 for positioning the I/O connector 50 to the housing 10, and a plurality of screws 90. The (portable) electronic device 100 further includes various modules for performing specific functions, such as circuit board, backlight module, display screen, for example. However, for the sake of simplicity, only the housing 10, the I/O connector 50, the positioning member 70, and the screws 90 are described in detail.

The housing 10 includes a base plate 12 and a sidewall 14 extending from a periphery of the base plate 12.

The I/O connector 50 is an input and output interface of the electronic device 100, for transmitting data between the electronic device 100 and another electronic device (not shown in FIGS.) or for charging the electronic device 100 by connecting a power line (not shown in FIGS.) to the I/O connector 50. The I/O connector 50 includes a main body 52, two locking portions 54 extending from opposite ends of the main body 52, and a connecting portion 56 extending from a side of the main body 52. The main body 52 is substantially a rectangular plate, and defines a receiving groove 522 at a side thereof opposite to the connecting portion 56. A plurality of connecting pins 524 are positioned in the receiving groove 522. The main body 52 includes a stepped surface 526 at the top thereof. The stepped surface 526 includes a first surface 5261, a second surface 5263, and a resisting surface 5265 connecting the first surface 5261 to the second surface 5263. Each locking portion 54 defines a locking hole 542 at an end thereof away from the main body 52. The locking holes 542 are configured to engage with two of the screws 90 to lock the I/O connector 50 on the sidewall 14 of the housing 10.

The positioning member 70 is made of electrically conductive materials. In the illustrated embodiment, the positioning member 70 is made of stainless steel. The positioning member 70 includes a base plate 72 and two latching arms 74 perpendicularly extending from opposite ends of the base plate 72 towards a same side of the base plate 72. The base plate 72 is substantially rectangular, and includes a first edge 721 and a second edge 723 opposite to the first edge 721. The base plate 72 includes two punched elastic sheets 725. Each elastic sheet 725 obliquely protrudes from a main portion of the base plate 72 at a portion of the base plate 72 adjacent to the first edge 721 towards the second edge 723. The elastic sheets 725 are located between the two latching arms 74. The base plate 72 further defines two keyholes 727, and each keyhole 727 is positioned besides an elastic sheet 725. The keyholes 727 engage with two screws 90, for locking the positioning member 70 to the sidewall 14 of the housing 10.

Each of the latching arms 74 includes a first latching portion 741 and a second latching portion 743 separately and perpendicularly extending from the base plate 72, in which the first latching portion 741 and the second latching portion 743 are parallel to each other. The first latching portion 741 is connected to the first edge 721 of the base plate 72, and is perpendicularly extending from the first edge 721. The second latching portion 743 is connected to and extends from the second edge 723 of the base plate 72. Each latching arm 74 further includes an elastic sheet 745 protruding from the first latching portion 741 towards the second latching portion 743. The elastic sheets 745 are slightly inclined towards an inner space located between the latching arms 74. In other words, the elastic sheets 745 are slightly inclined towards a center axis of the base plate 72.

In the illustrated embodiment, a top surface of the sidewall 14 of the housing 10 defines a mounting groove 16 communicating with an inner space of the housing 10. The I/O connector 50 is locked in the mounting groove 16 via the positioning member 70. The sidewall 14 includes a bottom surface 162 and a side surface 164 inside the mounting groove 16. The side surface 164 is perpendicularly connected to the bottom surface 162, and is positioned opposite to an outer surface of the sidewall 14. The bottom surface 162 and the side surface 164 cooperatively define a receiving room with an opening facing the inside of the housing 10, for receiving the I/O connector 50 and the positioning member 70.

The bottom surface 162 defines two fixing hole 1622 corresponding to the locking holes 542 of the I/O connector 50, respectively. A mounting portion 166 protrudes from the side surface 164, and is received in the mounting groove 16. The mounting portion 166 and the bottom surface 162 cooperatively define a containing groove 168, for receiving the main body 52 of the I/O connector 50. The outer surface of the sidewall 14 defines a mounting opening 1642 communicating with the containing groove 168. A profile of the mounting opening 1642 substantially matches with a profile of the main body 52 of the I/O connector 50.

The mounting portion 166 includes a base body 1662 and two blocking portions 1664 extending from opposite ends of the base body 1662 towards the bottom surface 162 of the sidewall 14. The base body 1662 is substantially a rectangular plate, and two fixing portions 1665 protrude from the base body 1662 opposite to the blocking portions 1664. Each fixing portion 1665 defines an engaging hole 1666 corresponding to one of the keyholes 727. The base body 1662 defines two receiving grooves 1667 and a through hole 1668. Each receiving groove 1667 is located at a side of one of the fixing portions 1665 away from the other one of the fixing portions 1665. The through hole 1668 is substantially rectangular, and is positioned between the fixing portions 1665. The receiving grooves 1667 and the through hole 1668 communicate with the containing groove 168. The receiving grooves 1667 are configured to receive the latching arms 74. The through hole 1668 is configured to receive the elastic sheets 725 of the positioning member 70.

In assembly, the positioning member 70 is positioned on the base body 1662 of the mounting portion 166, and the second edge 723 of the base plate 72 is positioned adjacent to the mounting opening 1642. The base plate 72 of the positioning member 70 is locked to the fixing portion 1665 of mounting portion 166 by two screws 90. The latching arms 74 of the positioning member 70 are latched in the receiving grooves 1667. The elastic sheets 725 pass through the through holes 1668, and are then received in the through holes 1668 and the containing groove 168. The elastic sheets 745 pass through the receiving grooves 1667, and are partly received in the receiving grooves 1667 and also partly received in the containing groove 168. The locking portions 54 of the I/O connector 50 are locked on the bottom surface 162 by two of the screws 90. The elastic sheets 725 elastically resist against the first surface 5261 of the I/O connector 50. One of the elastic sheets 745 elastically resists against the resisting surface 5265 from one side of the main body 52, and the other one of the elastic sheets 745 elastically resists against the resisting surface 5265 from another side of the main body 52.

In use, the elastic sheets 725 elastically resist against a top portion of the I/O connector 50, and the elastic sheets 745 elastically resist against opposite sides of the I/O connector 50, and thus the I/O connector 50 is positioned. In addition, the positioning member 70 is made of stainless steel, thus the positioning member 70 is a good conductor. While the elastic sheets 725 and the elastic sheets 745 are resisting against the I/O connector 50, the I/O connector 50 is at the same time electrically connected with the positioning member 70.

In an alternative embodiment, the mounting groove 16 may be defined in the inner surface of the sidewall 14. The mounting portion 166 may be omitted, and then the positioning member 70 is positioned on the bottom surface 162, and located above the I/O connector 50. A number of the elastic sheet 725 may be one or more than two, and then different latching forces are provided by the elastic sheet 725. Either the elastic sheet 725 or the elastic sheet 745 may be omitted, and then an elastic force from the elastic sheet 725 or an elastic force from the elastic sheet 745, as the case may be, is exerted on the I/O connector 50.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An electronic device comprising:
a housing defining a mounting opening at a sidewall of the housing, and a mounting groove communicating with the mounting opening and an inside space of the housing, the housing comprising a bottom surface and a side surface connected to the bottom surface inside the mounting groove, the side surface is positioned opposite to the sidewall, the housing further comprising a mounting portion protruding from the side surface toward the inside of the housing, the mounting portion and the bottom surface cooperatively defining a containing groove communicating with the mounting opening;
an I/O connector positioned in the containing groove, and partly received in the mounting opening; and
a positioning member made of electrically conductive materials, and fixed on the mounting portion of the housing in the containing groove and the mounting opening, the positioning member comprising at least one elastic sheet, and the at least one elastic sheet elastically resisting against the I/O connector.

2. The electronic device of claim 1, wherein the positioning member comprises a base plate, the base plate is fixed on the mounting portion, the at least one elastic sheet protrudes from the base plate.

3. The electronic device of claim 2, wherein the I/O connector comprises a main body and two locking portions extending from opposite ends of the main body, the at least one elastic sheet elastically resists against the main body.

4. The electronic device of claim 3, wherein the mounting portion comprises a base body and two blocking portions extending from opposite ends of the base body towards the bottom surface, the base body comprises two fixing portions, the base plate is fixed on the fixing portions, the base body defines a through hole positioned between the fixing portions, the at least one elastic sheet is inserted into the through hole, and elastically resists against the main body of the I/O connector.

5. The electronic device of claim 4, wherein the base plate defines two keyholes, each fixing portion defines an engaging hole corresponding to one of the keyholes, the electronic device further comprises two screws, the base plate is locked to the fixing portions by having the screws being inserted into the keyholes and the engaging holes.

6. The electronic device of claim 1, wherein the positioning member comprises a base plate and two latching arms perpendicularly extends from opposite ends of the base plate towards the I/O connector, the base plate is fixed on the mounting portion, a number of the at least two elastic sheet is two, the elastic sheets respectively protrude from the latching arms towards a center axis of the base plate, and resist against the I/O connector.

7. The electronic device of claim 6, wherein the I/O connector comprises a main body and two locking portions extending from opposite ends of the main body, the elastic sheets respectively resist the main body from opposite sides of the main body.

8. The electronic device of claim 7, wherein the mounting portion comprises a base body, two blocking portions extending from opposite ends of the base body towards the bottom surface, and two fixing portions protruding from the base body, the base plate is fixed on the fixing portions, the base body defines two receiving grooves communicating with the containing groove, and each of the receiving grooves is located besides the corresponding fixing portion, the elastic sheets are respectively inserted into the receiving grooves, and elastically resists against the main body of the I/O connector.

9. The electronic device of claim 6, wherein each latching arm comprises a first latching portion and a second latching portion parallel to the first latching portion, each of the elastic sheets protrudes from the first latching portion towards the second latching portion.

10. An electronic device comprising:
a housing comprising a base plate and a sidewall extends from the base plate, the sidewall defining a mounting opening and a mounting groove communicating with the mounting opening, the sidewall comprising a bottom surface and a side surface connected to the bottom surface inside the mounting groove, the housing further comprising a mounting portion protruding from the side surface, and received in the mounting groove, the mounting portion and the bottom surface cooperatively defining a containing groove communicating with the mounting opening;
an I/O connector positioned in the containing groove, and partly received in the mounting opening; and
an electrically conductive positioning member fixed on the mounting portion of the housing, the electrically conductive positioning member comprising at least one elastic sheet, and the at least one elastic sheet elastically resisting against the I/O connector.

11. The electronic device of claim 10, wherein the conductive positioning member comprises a base plate, the base plate of the electrically conductive positioning member is fixed on the mounting portion, the at least one elastic sheet protrudes from the base plate of the electrically conductive positioning member.

12. The electronic device of claim 11, wherein the I/O connector comprises a main body and at least one locking portions extending from the main body, the at least one elastic sheet elastically resists against the main body.

13. The electronic device of claim 12, wherein the mounting portion comprises a base body and two blocking portions extending from opposite ends of the base body towards the bottom surface, the base plate of the electrically conductive positioning member is fixed on the main body, the base body defines a through hole communicating with the containing groove, the at least one elastic sheet is inserted into the through hole, and elastically resists against the main body of the I/O connector.

14. The electronic device of claim 13, wherein the base plate of the electrical conductive positioning member defines two keyholes, the electronic device further comprises two screws, the base plate of the electrical conductive positioning member is locked to the base body via the screws being inserted into the key holes.

15. The electronic device of claim 10, wherein the conductive positioning member comprises a base plate and two latching arms perpendicularly extends from opposite ends of the base plate of the conductive positioning member towards the I/O connector, the base plate of the conductive positioning member is fixed on the mounting portion, the at least one elastic sheet is two elastic sheets, and the two elastic sheets respectively protrude from the latching arms, and resist against the I/O connector.

16. The electronic device of claim 15, wherein the I/O connector comprises a main body and two locking portions extending from opposite ends of the main body, the locking portions are locked on the bottom surface of the sidewall, the two elastic sheets respectively resist opposite sides of the main body.

17. The electronic device of claim 16, wherein the mounting portion defines two receiving grooves communicating with the containing groove, the elastic sheets are respectively inserted into the receiving grooves, and elastically resists against the main body of the I/O connector.

18. The electronic device of claim 15, wherein each latching arm comprises a first latching portion and a second latching portion parallel to the first latching portion, each of the two elastic sheets protrudes from the first latching portion towards the second latching portion.

19. An electronic device comprising:
a housing defining a mounting opening at a sidewall of the housing, and a mounting groove communicating with the mounting opening and inside of the housing;
an I/O connector is positioned in the mounting groove, and partly received in the mounting opening; and
a positioning member made of electrically conductive materials, and fixed within the mounting groove for positioning the I/O connector, the positioning member comprising at least one elastic sheet, and the at least one elastic sheet elastically resisting against the I/O connector.

20. The electronic device of claim 19, wherein the housing comprises a bottom surface and a side surface in the mounting groove, the I/O connector is fixed on the bottom surface, the positioning member is positioned on the bottom surface, and is located above the I/O connector.
